(19) United States
(12) Patent Application Publication
(10) Pub. No.: US 2010/0233659 A1
(43) Pub. Date: Sep. 16, 2010

(54) METHOD OF DESIGNING A TOOTH REPLACEMENT PART, A METHOD OF PROCESSING A DESIGNED TOOTH REPLACEMENT PART, A TOOTH REPLACEMENT PART, AND A COMPUTER-READABLE MEDIUM

(75) Inventors: Stephan Holzner, Schaftlarn (DE); Gerhard Weber, Purgen (DE)

Correspondence Address: RISSMAN HENDRICKS & OLIVERIO, LLP, 100 Cambridge Street, Suite 2101, BOSTON, MA, 02114, US

(73) Assignee: INSTITUT STRAUMANN AG, Basel (CH)

(21) Appl. No.: 12/670,055

(22) PCT Filed: Jul. 24, 2008
(86) PCT No.: PCT/EP2008/006094

§ 371 Date: Apr. 14, 2010

(30) Foreign Application Priority Data
Jul. 25, 2007 (DE) 10 2007 034 653.2

(51) Int. Cl. A61C 13/00; A61C 9/00

(52) U.S. Cl. 433/215; 433/171

(57) ABSTRACT

Method of designing a tooth replacement part, which is intended to be mountable on a residual tooth area and in which a spacing (1) is provided between the tooth replacement part (2) and the residual tooth area (3), and the subsequent step of examining whether one or more undercuts (4) exist in the tooth replacement part. Method of processing a designed tooth replacement part having one or a plurality of undercuts, wherein a spacing is provided between the tooth replacement part and a residual tooth area and wherein a shape of the spacing is modified so as to remove the undercut or undercuts from the tooth replacement part. Method of avoiding the formation of undercuts originating from the provision or the modification of a spacing. Tooth replacement part having a spacing, wherein the spacing of the tooth replacement part has first and second spacing areas and an intermediate transition area, said transition area being free from undercuts. Computer-readable medium with instructions for said methods.

The present invention relates to a method of designing a tooth replacement part, a method of processing a designed tooth replacement part, a tooth replacement part, and a computer-readable medium.

From the prior art it is known to measure the dimensions of a residual tooth area after dental preparation by optical scanning executed directly in the patient's mouth or by optically scanning a model that represents the situation in the patient's mouth. The data acquired by optical scanning allow e.g. also a detection of undercuts in the residual tooth area.

In addition, it is known from the prior art to execute digital modelling of tooth replacement part models. Tooth replacement parts can thus be designed with high accuracy so that additional processing will not be necessary after the production of the tooth replacement part. In such modelling processes the scan data of the residual tooth area are taken into consideration.

It is the object of the present invention to provide a method of designing a tooth replacement part, a method of processing a designed tooth replacement part, a tooth replacement part, and a computer-readable medium, so that the modelling of tooth replacement parts can be executed with high flexibility which leads to easily producible tooth replacement parts.

This object is achieved by the methods according to claim 1, 16 or 26, a tooth replacement part according to claim 27 as well as a computer-readable medium according to claim 29.

Preferred embodiments are disclosed in the dependent claims.

According to one method a tooth replacement part is designed, which is intended to be mountable on a residual tooth area. A spacing is provided between the tooth replacement part and the residual tooth area, and it is examined whether, after the provision of the spacing, one or more undercuts exist in the tooth replacement part.

By means of the examination for undercuts, it is achieved that tooth replacement parts can be produced easily, since designed, undercut-free tooth replacement parts can be produced at a reasonable price e.g. by means of 3-axis milling machines. If undercuts should be detected, production can be executed by means of a 3+1-, 4- or 5-axis milling machine, but this will be more expensive.

Undercuts of the tooth replacement part can originate from the shape of the residual tooth area, they may, however, also originate from the provision of a spacing.

During the design process of a tooth replacement part provided with a spacing, the spacing can be chosen in a flexible manner, since it is guaranteed that, due to the step of examining the tooth replacement part for undercuts, which is executed subsequent to the designing steps, it can be found out whether one or a plurality of undercuts originated from the provision of the spacing.

By means of the examination of the tooth replacement part with respect to existing undercuts after the provision of the spacing, it is achieved that undercuts originating from a spacing will be detected in any case. Undercuts originating from the shape of the residual tooth area can then also be detected together with said first-mentioned undercuts so that an additional examination of the tooth replacement part prior to the provision of the spacing will be superfluous (though possible). The tooth replacement part can thus be designed with little expenditure of time. The spacing provided can serve to improve the fit of the tooth replacement part and of the residual tooth area.

The subsequent examination step is carried out preferably automatically after the provision of the spacing, or after any change or modification of a spacing.

The spacing provided can comprise at least two, three, four or more spacing areas. According to a preferred embodiment, a transition area can be provided between two neighbouring spacing areas, a respective transition area being preferably provided between all the neighbouring spacing areas.

The transition area and/or the transition areas between neighbouring spacing areas can have at various locations thereof different and/or identical lengths and/or different and/or identical shapes. The length of a transition area can be measured between the two ends of the transition area. For example, the length of a transition area may have different values along the respective circumference of a tooth stump (the circumference extends around the tooth axis) so as to avoid undercuts in the tooth replacement part to be produced and/or in order to guarantee an optimum fit of the tooth replacement part. Preferably, e.g. the various lengths of a transition area can merge continuously with one another along the circumference so that no areas with abrupt changes will be formed. Such areas might e.g. lead to mechanical loads on the tooth replacement part. Additional parameters which the transition area and/or the transition areas may exhibit can be the spacing difference at the respective ends of the transition area and/or the position of the transition area or of the transition areas. Also these parameters may have different and/or identical values at various locations of the transition area or transition areas.

A change or modification of a spacing provided and/or a change or modification of the transition area or transition areas can preferably be executed such that changes and/or modifications, made e.g. for removing one and/or a plurality of undercuts, will be minimal.

By providing the spacing with two or more spacing areas, it is possible to design e.g. the overall thickness of the spacing such that it varies in different areas between the residual tooth area and the tooth replacement part. This allows a particularly high flexibility in the design of the tooth replacement part. An existing transition area provided between e.g. two spacing areas can serve to provide a more variable shape of the spacing. According to a preferred embodiment, the thickness is smaller in the area of the preparation line than in the residual spacing area or in a part thereof.

The two or more spacing areas of the spacing can have different thicknesses.

The spacing can be composed of various spacing elements, said spacing elements being provided e.g. in the form of layers. The layers can e.g. be so-called cement layers and stump varnish layers. The so-called cement layer can comprise the space for the dental cement for providing an optimum adherence of the tooth replacement part to the residual tooth area, and the so-called stump varnish layer can be an additional layer which can provide space for some other material or again for dental cement.

With the aid of the various spacing areas or with the aid of the use of different spacing elements, it is possible to design the spacing in an optimum and flexible manner as regards the residual tooth area and the tooth replacement part.

The method disclosed additionally allows to examine whether said one or said plurality of undercuts exist in the tooth replacement part before the spacing is provided. The existing undercut or undercuts can be removed.

By examining whether one or a plurality of undercuts existed in a tooth replacement part already prior to the provision of the spacing, it can e.g. be found out that the spacing did not create any undercut, but that the undercut in question had already existed prior to the provision of the spacing. Hence, it would be possible to remove the undercut or undercuts from the tooth replacement part including such undercut(s) prior to providing the spacing. Likewise, it would be possible to remove undercuts which originated from the provision of the spacing.

It will be of advantage that, if one or a plurality of undercuts exist, it can automatically be indicated that the spacing should be modified. It is particularly advantageous that, with the aid of the automatic indication, the spacing can automatically by modified such that the tooth replacement part will be free from undercuts.

With the aid of said automatic indication of the necessity of modifying a spacing, it can be guaranteed that tooth replacement parts having no undercut(s) will be designed. If it is, in addition, automatically indicated that the spacing should be provided such that the tooth replacement part will be free from undercuts, the tooth replacement part can be designed in a less time-consuming manner, since there is no necessity of going through various modifications of the spacing so as to find a spacing which will not cause any undercuts in the tooth replacement part.

It may be that the tooth replacement part is free from undercuts without any spacing being provided.

In addition, a method will be of advantage which, making use of data obtained by optically scanning the residual tooth area in a jaw or by optically scanning a model of the residual tooth area, is able to determine the interior shape of the tooth replacement part. The interior shape of the tooth replacement part is here the area of the tooth replacement part facing the residual tooth area.

According to another preferred embodiment, existing undercuts are indicated. This can be done optically, e.g. by gray scale values, shades, pseudocolours, numerical values or contours, e.g. by means of a display or a printout. The data for indicating the undercut or undercuts can also be stored in a data record. The optical display by means of gray scale values, shades, pseudocolours, numerical values or contours can comprise the spacing on the residual tooth area, a view of the tooth replacement part with the spacing, or a transparent representation of the tooth replacement part with the spacing on the residual tooth area. In addition, an optical or acoustic signal can be generated, which indicates that some kind of undercut or a plurality of undercuts actually exist. Such a signal is then produced independently of the location of the undercut.

The representation of existing undercuts allows a user e.g. to recognize easily in which area of the tooth replacement part an undercut occurs and which dimensions said undercut assumes. In addition, an optical or an acoustic signal can draw a user's attention to the fact that an undercut exists in a designed tooth replacement part. This will be advantageous especially in cases where an undercut is not readily visible in the representation in question, since the undercut is located e.g. on a rear side that is not shown.

One or a plurality of data records, which can be generated by means of one or a plurality of computers when a tooth replacement part is being designed, can describe the tooth replacement part. The data record or data records of a tooth replacement part can comprise characteristics of the tooth replacement part, of the residual tooth area or of the spacing. In addition, the data record or data records can comprise information on the material which is to be used for making the tooth replacement part or information indicating which material is to be introduced in the space provided by the spacing.

Such data records allow a user to access easily and rapidly information on a tooth replacement part, a spacing provided, or a residual tooth area. In addition, a tooth replacement part can be produced making use of such a data record (milling or any other rapid prototyping method).

The subsequent step of examining may also be intended for execution only if (i.e. it will not be executed in other cases) a spacing is provided, which has different thicknesses at least two different locations, in particular if the dimensions of the spacing are larger in an area that is remote from the preparation limit than in an area close to the preparation limit. Precisely this kind of spacings e.g. may result in the formation of undercuts.

In accordance with another method, an already designed tooth replacement part is processed. The tooth replacement part may have one or a plurality of undercuts, and a spacing is provided between the tooth replacement part and the residual tooth area on which the tooth replacement part is intended to be mountable. The shape of the spacing can be modified so as to remove the undercut or undercuts from the tooth replacement part.

By processing a designed tooth replacement part, the tooth replacement part itself or the spacing provided, or both said elements, can be modified also subsequently. It is thus possible to produce an optimally fitting tooth replacement part with a spacing provided.

The shape of the spacing can be modified by selecting one or a plurality of areas of the spacing and by subsequently modifying the selected area or areas. The spacing can also be processed, i.e. modified, by selecting one or a plurality of spacing elements or parts thereof and by subsequently modifying the selected spacing elements or spacing element parts.

The shape of the spacing in said one and/or in said plurality of areas can be modified differently and/or identically. When the shape of the spacing is modified e.g. differently in a plurality of selected areas, undercuts can be avoided and an optimum fit of the tooth replacement part can, for example, be accomplished in this way.

The shape of the spacing can be modified e.g. by enlarging or reducing the overall thickness or the thickness in a selected area of the spacing.

On the basis of this variable selection and modification of the shape of the spacing, it is possible to provide a spacing which is optimally adapted to the tooth replacement part and the residual tooth area.

In addition, it will be of advantage to modify the shape of the spacing automatically, preferably with due regard to boundary parameters. Boundary parameters may, for example, be the length or the thickness of the preparation line, the stability of the tooth replacement part or the grain size of the cement.

The automatic modification of the shape of the spacing can result in a reduced expenditure of time in the design process and also in the processing of an already designed tooth replacement part. By incorporating the boundary parameters, it can additionally be guaranteed that the tooth replacement part and the spacing provided will comply with given criteria.

In addition, the spacing may comprise two, three, four or more spacing areas, and, preferably, the dimensions and/or the shape of a transition area or of a plurality of transition areas between spacing areas can be modified. The dimensions can preferably be modified with due regard to the preparation line, which must e.g. be dimensioned such that it is not shorter than a minimum length. The minimum length of the preparation line can preferably be 0.2-0.3 mm. The shape of the transition area can be modified so as to avoid an undercut.

The two or more spacing areas of the spacing provided allow the spacing to be designed e.g. such that it has different thicknesses in said two or more spacing areas, whereby an optimum shape of the spacing with respect to the tooth replacement part and the residual tooth area will be obtained. Neighbouring spacing areas can have provided between them a transition area whose configuration can be varied by modifying the dimensions and/or the shape thereof.

The transition areas between neighbouring spacing areas can be modified such that they have at various locations thereof different and/or identical lengths and/or different and/or identical shapes. The length of a transition area can be measured between the two ends of the transition area. For example, the length of a transition area may have different values along the respective circumference of a tooth stump, whereby undercuts in the tooth replacement part can be avoided and whereby e.g. an optimum fit of the tooth replacement part can be guaranteed.

In addition, one or a plurality of suggestions for modifying the shape of the spacing can be made automatically, and, preferably, one of these suggestions can be selected and then executed automatically.

Thanks to the fact that an automatic suggestion or automatic suggestions for modifying the shape of a spacing are made and the suggestion or suggestions are then possibly executed automatically, it is not necessary that the user himself modifies the spacing provided, but he can make use of the automatic suggestion, whereby the amount of time required for designing a tooth replacement part or for processing a designed tooth replacement part can be reduced. A suggestion can be selected by the user, or it is possible to select a suggestion automatically on the basis of given criteria (e.g. stability or wall thickness of the tooth replacement part).

After the modification of the shape of the spacing, it can be examined automatically whether one or a plurality of undercuts exist in the tooth replacement part.

It can thus be guaranteed that when an already designed tooth replacement part with one or a plurality of undercuts is being processed, the shape of the spacing will be modified such that the tooth replacement part will be free from undercuts. The automatic examination can be executed without this being noticed by the user and without it being necessary that the user becomes aware of this examination. The user can be informed if one or a plurality of undercuts should be detected during the automatic examination. The user can obtain information on all the results of the automatic examination.

According to another method, a tooth replacement part which is intended to be mountable on a residual tooth area can be designed by including the step of providing or modifying a spacing between the tooth replacement part and the residual tooth area, wherein said provision or modification of the spacing can only be executed such that the provision or modification of the spacing will not result in the formation of an undercut in the tooth replacement part. To this end, suitable measures can be taken, which guarantee that no undercuts will be formed due to the provision/modification of the spacing.

If a residual tooth area that is free from undercuts exists, the spacing can e.g. be provided or modified such that it extends parallel to the surface of the residual tooth area. The spacing will then be free from undercuts as well.

If the spacing is intended to have a plurality of spacing areas whose surfaces extend each e.g. parallel to the surface of the residual tooth area, the method can be so conceived that the shape of the transition area or transition areas can only be chosen such that, when the direction of insertion of the tooth replacement part is e.g. perpendicular to the basal plane, the transition area or transition areas will not project beyond an imaginary plane which extends parallel to the direction of insertion and through the end of the transition area or transition areas towards the preparation line. For example, the shape of the transition area or areas can be chosen such that the surface of the transition area will define an angle of 2°-3° with the direction of insertion of the tooth replacement part.

When a spacing is being modified, limits can be predetermined, e.g. in the form of surfaces (flat or curved) or lines, beyond which the surface of the tooth replacement part must not be moved during the modification process, since otherwise an undercut would be formed.

In addition, a tooth replacement part is provided, which is intended to be mountable on a residual tooth area, to which the tooth replacement part belongs, in such a way that a spacing is provided between said tooth replacement part and said residual tooth area. The spacing of the tooth replacement part comprises a first and a second spacing area and an intermediate transition area, said transition area being free from undercuts. If no such transition area is provided, the tooth replacement part may have an undercut. The spacing of the tooth replacement part may also comprise three, four or more spacing areas and intermediate transition areas, said transition areas being free from undercuts.

The invention also relates to a computer-readable data carrier comprising instructions which, when inputted in a computer, will execute one of the above-described methods or one of the methods described hereinbelow.

The tooth replacement parts may be inlays, overlays, onlays, small caps, crowns, primary crowns, secondary crowns, bridges, frames, dentures (false teeth), abutments or implants, etc.

Preferred embodiments of the present invention will be explained with reference to the figures enclosed, in which:

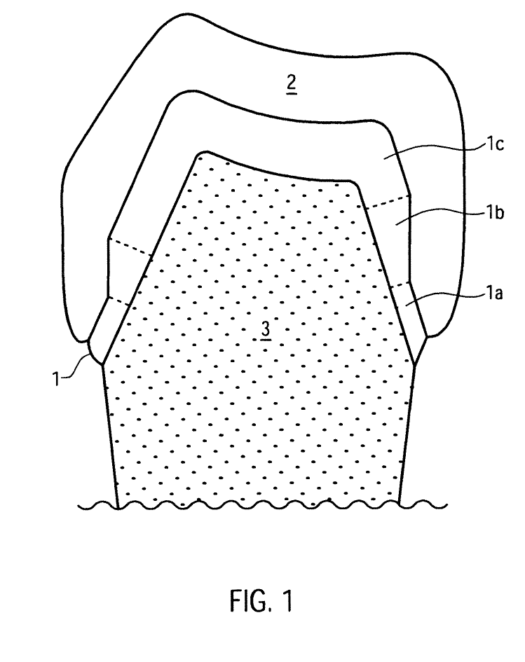

FIG. 1 shows a section through a tooth replacement part with a spacing, which is mounted on a residual tooth area;

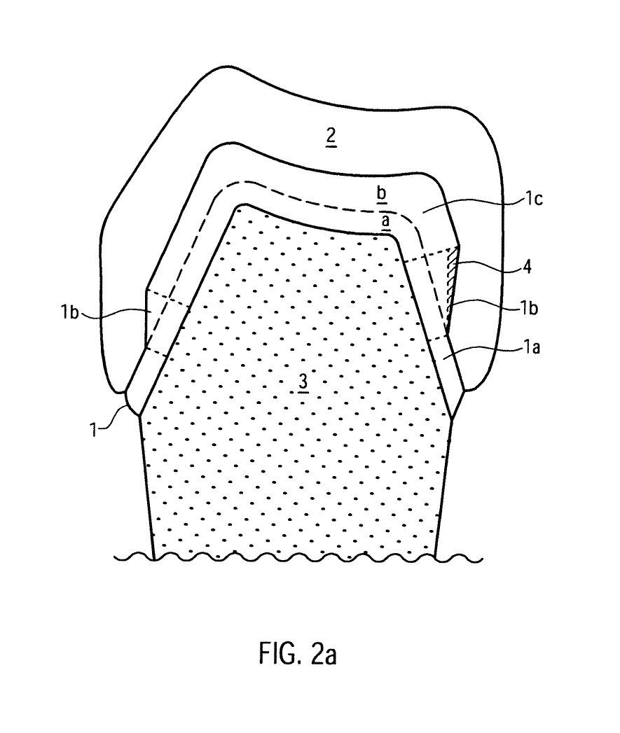

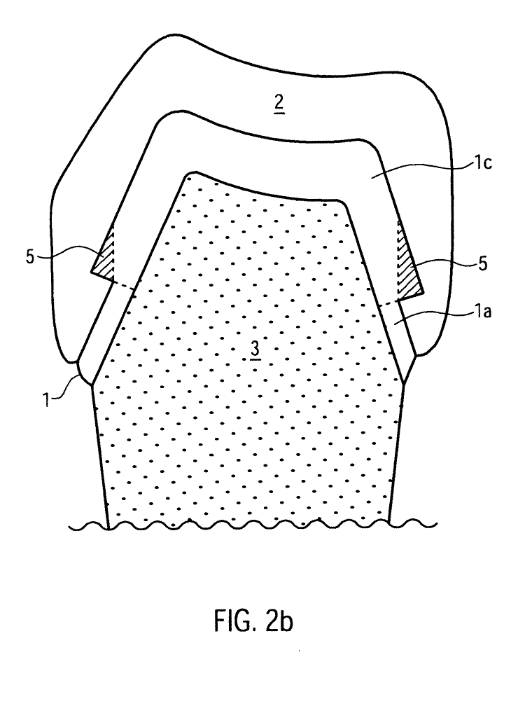

FIG. 2 shows a section through a tooth replacement part with a spacing with/without a transition area;

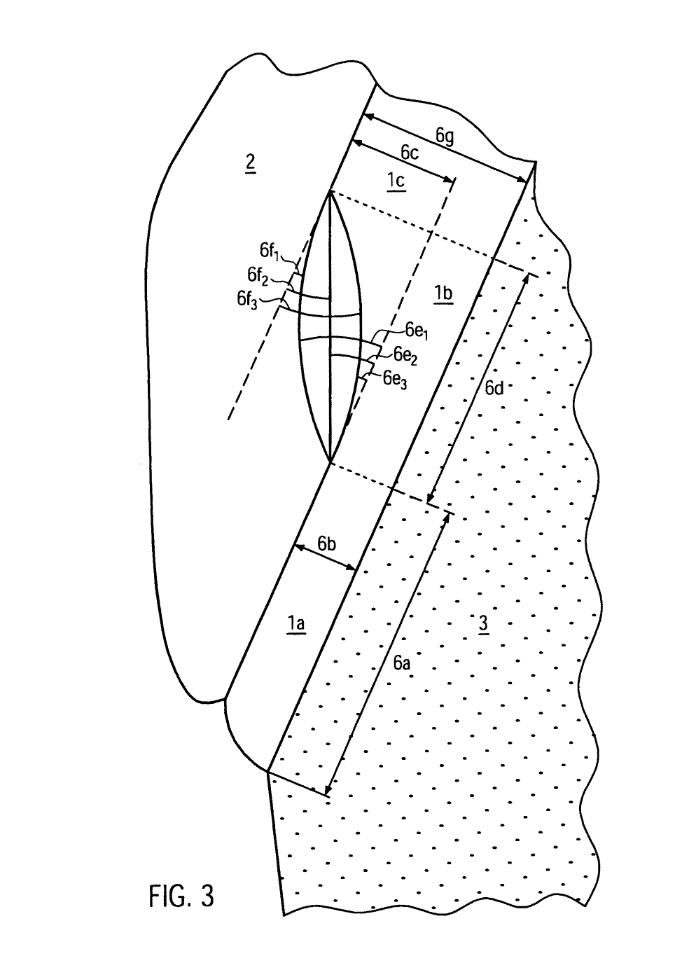

FIG. 3 shows possible boundary parameters of the spacing;

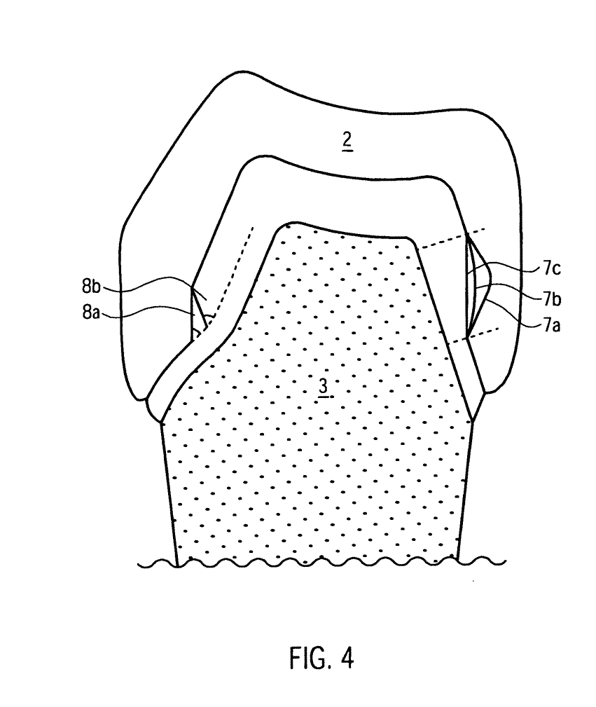

FIG. 4 shows the dimensions and the shape of the transition area of the spacing in the various spacing areas;

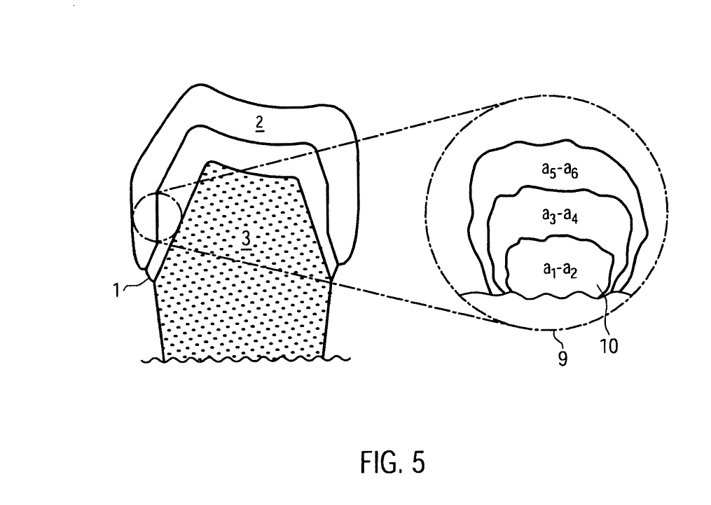

FIG. 5 shows an optical representation of the undercuts;

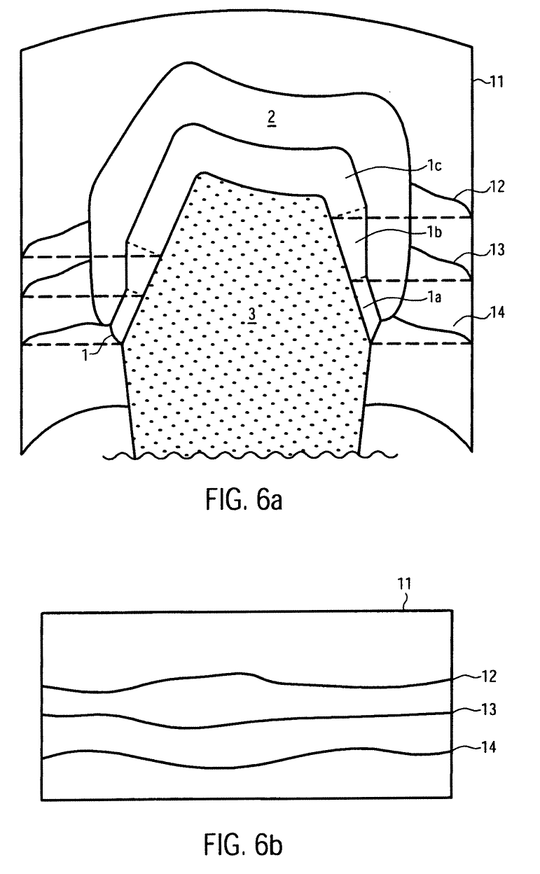

FIG. 6 shows a representation of a profile of the preparation line and of the two lines of a transition area.

FIG. 1 shows a schematic section through a tooth replacement part 2 with a spacing 1. The depicted spacing 1 comprises two spacing areas 1a, 1c as well as a transition area 1b. The spacing 1 may comprise one, two, three, four, five or more spacing areas, and transition areas can, in turn, be provided between the respective spacing areas. The spacing 1 can be filled e.g. with dental cement so as to guarantee that the tooth replacement part 2 will be retained on the residual tooth area 3. The thickness of the spacing is constant within each spacing area, but it may also vary within predetermined tolerances, such as 5%, 10% or 20%. The spacing can have (nominal) thicknesses of 10 μm, 15 μm, 20 μm, 25 μm or 30 μm.

FIG. 2a shows a schematic section through a tooth replacement part in which the spacing comprises two spacing areas 1a, 1c as well as a transition area 1b. Depending on the shape of the residual tooth area 3 and the position of the transition area 1b, an undercut 4 may be formed in the tooth replacement part 2 through the spacing 1 provided. It is, however, also possible that no undercut 4 will be formed in the tooth replacement part 2 in spite of the spacing 1 (cf. the left part of the transition area 1b).

The spacing 1 is composed of two spacing elements a, b. Spacing element a corresponds to a cement gap and spacing element b corresponds to a stump varnish layer. In the area of the preparation limit only spacing element a, but no spacing element b, is present. The spacing element b has a constant thickness in the spacing area 1c and, in the transition area 1b, it has a thickness that decreases towards the preparation limit (in the present case it decreases, by way of example, to zero).

Also FIG. 2b shows a schematic section through a tooth replacement part 2 in which the spacing 1 comprises two spacing areas 1a, 1c. A transition area does, however, not exist. This may lead to one or a plurality of undercuts 5 in the tooth replacement part 2. This figure shows clearly that, especially by providing a spacing 1 with different thicknesses in the various spacing areas, undercuts 5 may be formed in the tooth replacement part 2, even if the residual tooth area 3 itself should be free from undercuts. It is true that the undercuts 5 in the tooth replacement part 2 can be reduced or removed through transition areas, but this depends concretely on the respective parameters defining a transition area, such as the length of the transition area, the spacing difference at the respective ends of the transition area or the position of the transition area (cf. FIG. 3).

FIG. 3 shows possible boundary parameters 6a-6g which can be taken into account e.g. in the case of an automatic indication of the provision of the spacing 1. The length 6a of the preparation line (also referred to as preparation limit) is normally fixedly predetermined so as to obtain a precise and well-fitting closure between the tooth replacement part 2 and the residual tooth area 3. A minimum length of the preparation line can be given. The preparation line must not be shorter than this minimum length. The thickness 6b of the spacing in the area of the preparation line can be determined by the grain diameter of the dental cement to be used. The spacing difference 6c measured at the respective ends of the transition area 1b can be used for defining the thickness difference between the two spacing areas 1a, 1c shown here. In addition, the length 6d of the transition area 1b can be varied, whereby undercuts can be avoided. Various shapes of the transition area 1b can be obtained e.g. by selecting various angles 6e₁-6e₃ and 6f₁-6f₃. When the angles 6e₂ and 6f₂ are identical in size, the shape of the transition area can assume the shape of a straight line in the sectional view shown. The angles 6e and 6f may, however, also be different in size. When seen in a sectional view, the transition area can have a straight shape, a curved shape (concave or convex portion of the tooth replacement part) or an arbitrary shape. The thickness of the spacing in the spacing area 1c is designated by reference numeral 6g.

FIG. 4 shows various shapes 7a-7c and various dimensions 8a, 8b of the transition area 1b of the spacing 1. By modifying the dimensions of the transition area, e.g. while maintaining or modifying the angle (cf. FIG. 4) between the residual tooth area and the surface of the transition area, it is possible to avoid the formation of an undercut through the spacing 1 provided. The dimensions 8a, 8b of the transition area can be modified e.g. while maintaining the angle defined by the transition area and an imaginary line of one of the spacing elements. The shape 7a-7c of the transition area 1b can be modified so as to avoid an undercut in the tooth replacement part by the spacing 1 provided, when e.g. the length 6d of the transition area is predetermined.

FIG. 5 shows an exemplary representation 9 of an undercut of a tooth replacement part 2. The left part of FIG. 5 shows the tooth replacement part attached to the residual tooth area, with a spacing provided therebetween, said tooth replacement part having an undercut. In the right part of FIG. 5 it is shown how such an undercut can be depicted graphically. The undercut is exemplarily shown on the basis of contours 10. In the case shown, the different areas represent various configurations of the undercut, which can, in addition, be designated by alphabetical indications of area. The various contour areas may, however, also have pseudocolours or gray scale values or shades or numerical values or the like. A combination of the various modes of representation can be used as well.

FIG. 6a is an exemplary transfer of the profile of the preparation line 14 and of the two lines of a transition area 12, 13 to the circumferential surface 11 of a cylinder surrounding a residual tooth area 3 which has a tooth replacement part 2 attached thereto. FIG. 6b shows the profile of the respective curves on the circumferential surface of the cylinder unrolled into a plane. It is, for example, also possible to mark on the circumferential surface of the cylinder areas in which undercuts occur.

When executing a method, a tooth replacement part can e.g. be provided with a spacing. The tooth replacement part designed is intended to be mountable on a residual tooth area and, as shown e.g. in FIG. 2a, the tooth replacement part may have an undercut 4. This undercut 4 can be detected when the tooth replacement part 2 is examined with respect to possibly existing undercuts.

The examination of the designed tooth replacement part with respect to possibly existing undercuts can be executed by means of one or a plurality of existing data records describing the designed tooth replacement part, for example from different directions e.g. with respect to an axis of the tooth replacement part. From the different directions, various views of the tooth replacement part can be obtained and also the undercut or undercuts may not exist or exist in different configurations. For example, when the examination direction is 10°, 20° or 30°, e.g. perpendicular to the basal plane (cf. the wavy line in the figures; plane where the tooth enters the gums), no undercuts may be seen, whereas in a 0° examination direction one or a plurality of undercuts may be seen.

The examination direction may e.g. be given through an already known insertion direction of the tooth replacement part onto the residual tooth area, and said insertion direction may e.g. depend on the orientation possibilities of the milling cutter used. The insertion direction of the tooth replacement part onto the residual tooth area can also be chosen in accordance with existing undercuts.

The undercut or undercuts detected by examining the designed tooth replacement part can be depicted graphically, as is shown exemplarily in FIG. 5. For removing e.g. an existing undercut, the shape of the spacing can be modified, but it is also possible to make one or more suggestions for modifying the shape of the spacing. One of these suggestions can then be selected and subsequently realized automatically.

For executing one or a plurality of the methods, a computer can be provided.

1. A method of designing a tooth replacement part, which is intended to be mountable on a residual tooth area, said method comprising the following steps:
providing a spacing between the tooth replacement part and the residual tooth area,
the subsequent step of examining whether one or more undercuts exist in the tooth replacement part.

2. A method according to claim 1, wherein the spacing comprises two, three, four or more spacing areas.

3. A method according to claim 2, wherein a transition area is provided between two neighbouring spacing areas.

4. A method according to claim 3, wherein the transition area and/or the transition areas between neighbouring spacing areas have at various locations thereof different and/or identical lengths and/or different and/or identical shapes.

5. A method according to claim 2, wherein at least two spacing areas have different thicknesses.

6. A method according to claim 1, wherein the spacing is composed of various spacing elements.

7. A method according to claim 1, wherein it is examined whether one or a plurality of undercuts exist in the tooth replacement part before the spacing is provided.

8. A method according to claim 1, wherein said one or said plurality of undercuts are removed.

9. A method according to claim 1, wherein if one or a plurality of undercuts exist, it will automatically be indicated how the spacing can be modified such that undercuts will no longer exist.

10. A method according to claim 8, wherein with the aid of said automatic indication, the spacing will automatically be modified such that undercuts will no longer exist in the tooth replacement part.

11. A method according to claim 1, wherein the tooth replacement part is free from undercuts without any spacing being provided.

12. A method according to claim 1, wherein making use of data obtained by optically scanning the residual tooth area in a jaw or a model of the residual tooth area, an interior shape of the tooth replacement part is determined.

13. A method according to claim 1, wherein the undercut or undercuts are indicated.

14. A method according to claim 13, wherein the undercut or undercuts are indicated by one or more of the following: gray scale values; colour grades; pseudocolours; hatchings; numerical values; letters, contours.

15. A method according to claim 1, wherein a data record or a plurality of data records describing the tooth replacement part are generated by one or a plurality of computers.

16. A method of processing a designed tooth replacement part having one or a plurality of undercuts, wherein a spacing is provided between the tooth replacement part and a residual tooth area on which the tooth replacement part is intended to be mountable, comprising,
a shape of the spacing is modified so as to remove the undercut or undercuts from the tooth replacement part.

17. A method according to claim 16, wherein the shape of the spacing is modified automatically.

18. A method according to claim 16, wherein the shape of the spacing is modified by selecting one or a plurality of areas of the spacing and by subsequently modifying said area or areas.

19. A method according to claim 18, wherein the shape of the spacing is modified differently and/or identically in said one and/or in said plurality of areas.

20. A method according to claim 16, wherein the shape of the spacing is modified by enlarging or reducing the thickness of the spacing.

21. A method according to claim 16, wherein the shape of the spacing is modified automatically with regard to boundary parameters.

22. A method according to claim 16, wherein the spacing comprises two, three, four or more spacing areas, wherein the dimension and/or the shape of a transition area or of a plurality of transition areas between spacing areas is modified.

23. A method according to claim 22, wherein the transition areas between neighbouring spacing areas are modified such that they have at various locations thereof different and/or identical lengths and/or different and/or identical shapes.

24. A method according to claim 16, wherein one or a plurality of suggestions for modifying the shape of the spacing are made automatically.

25. A method according to claim 16, wherein after each modification of the shape of the spacing, it is automatically examined whether one or a plurality of undercuts exist in the tooth replacement part.

26. A method of designing a tooth replacement part which is intended to be mountable on a residual tooth area, said method comprising the following step:
providing or modifying a spacing between the tooth replacement part and the residual tooth area, wherein said provision or modification of the spacing can only be executed such that the provision or modification of the spacing will not result in the formation of an undercut in the tooth replacement part.

27. A tooth replacement part which is intended to be mountable on a residual tooth area, said tooth replacement part comprising a spacing,
the spacing of the tooth replacement part comprises first and second spacing areas and an intermediate transition area, said transition area being free from undercuts.

28. A tooth replacement part according to claim 27, wherein, if no transition area were provided, there would be an undercut.

29. A computer-readable medium with instructions to one or a plurality of computers for the execution of the method of claim 1.
